(19) United States
(12) Patent Application Publication
(10) Pub. No.: US 2010/0269796 A1
(43) Pub. Date: Oct. 28, 2010

(54) Regulator for gas engine and gaseous fuel supplying device

(75) Inventor: Toshio Namatame, Kanagawa-ken (JP)

Correspondence Address: RADER FISHMAN & GRAUER PLLC, LION BUILDING, 1233 20TH STREET N.W., SUITE 501, WASHINGTON, DC, 20036, US

(73) Assignee: NIKKI CO., LTD., Atsugi (JP)

(21) Appl. No.: 12/662,403

(22) Filed: Apr. 15, 2010

(30) Foreign Application Priority Data
Apr. 22, 2009 (JP) 2009-103654

(51) Int. Cl. F02M 21/04; F02B 43/00; F02D 33/02

(52) U.S. Cl. 123/527

(57) ABSTRACT

According to the present invention of the simple structure in which the back pressure chamber of the inner vent type regulator is divided by the inner vent diaphragm and the displacement limitation rod protrudes from the center portion thereof to the center portion of the pressure regulation diaphragm, it is possible to suppress the variation in air-fuel ratio to a minimum both when the air cleaner is blocked and at the time of high load operation, without being accompanied by a rise in costs.

### BACKGROUND OF THE INVENTION

1. Field of the Invention

The present invention relates to a regulator for a gas engine and a gaseous fuel supplying device. In particular, the present invention relates to a regulator of a gas engine and a gaseous fuel supplying device which includes a function of suppressing a variation in air-fuel ratio to a minimum even when there is a cause of variation in negative intake pressure such as a blocking in an air cleaner.

2. Description of the Related Art

For example, in a outer vent type regulator in which a back pressure chamber 3b is equipped with an air hole 39, such as a regulator 3B which regulates a liquefied gaseous fuel such as LPG to a gaseous fuel having a predetermined pressure and supplies the gaseous fuel to a gas engine as shown in FIG. 3A, since negative pressure applied to a pressure regulation chamber (a second chamber) 3a increases when an air cleaner is blocked, a gas flow rate thereby increases (see a graph in FIG. 4A). Thus, the air-fuel ratio of the supplied fuel may become an over-concentration and this may cause a rich engine breakdown.

In regard to this, an inner vent type regulator in which an air hole 39 thereof and a downstream side of an air cleaner are connected by an inner vent tube 6, like a regulator 3C as shown in FIG. 3B, is also well known. In the regulator 3C, if pressure is balanced out between a pressure regulation chamber 3a and a back pressure chamber 3b into which a negative intake pressure is introduced, a situation can be avoided where the gas flow rate becomes excessive when the air cleaner is blocked(see a graph in FIG. 4B).

However, in the inner vent type regulator 3C, there is a problem in which the negative pressure of the back pressure chamber 3b side excessively increases at the time of high load operation, which thereby decreases the gas flow rate, and may cause a lean engine breakdown. In this manner, the decline in gas flow rate is due to a reduction in the pressure differential between the venturi negative pressure applied to the pressure regulation chamber 3a and the inner vent tube 6 side, thereby decreasing the stroke of a diaphragm 31 that divides the pressure regulation chamber 3a and the back pressure chamber 3b.

Regarding the above-mentioned problems, in Japanese Patent Application Laid-Open No. 9-21355, there is described a technique in which an air-fuel ratio control device, which detects detection data on O₂ concentration in exhaust gas and detection data on the idle state of the engine, suppresses the variation in air-fuel ratio to a minimum when there is a change in various engine operation conditions including the blocking of the air cleaner by regulating the supply pressure of the gaseous fuel with a supply pressure regulation means in cases where the detection values of the O₂ sensor deviate from a predetermined range.

However, to perform the technique, there is a problem that in addition to the preparation of an air-fuel ratio control device as an electronic control unit equipped with a control program, there is also a need for a plurality of sensor means including the O₂ sensor and a supply pressure regulation means, making the structure complicated and the production costs higher.

### SUMMARY OF THE INVENTION

The present invention has been made to solve the above-mentioned problem, and with regard to a regulator that supplies gaseous fuel for a gas turbine, an object thereof is to suppress a variation in air-fuel ratio to a minimum both when the air cleaner is blocked and at the time of high load operation, without being accompanied by a rise in costs.

Thus, the present invention provides an inner vent type regulator for a gas engine in which a pressure regulation chamber and a back pressure chamber are divided by a pressure regulation diaphragm, the pressure regulation chamber has a fuel introduction valve that is opened and closed by the reciprocating displacement of the pressure regulation diaphragm and is also connected to an intake passage by a fuel supply tube, and the back pressure chamber is connected to the intake passage on the downstream side of an air cleaner by an inner vent tube, with the inner vent type regulator transporting gaseous fuel which has been regulated at a predetermined pressure, while an negative intake pressure is introduced into the back pressure chamber, wherein the back pressure chamber is further divided into a negative pressure introduction portion on the pressure regulation diaphragm side to which the inner vent tube is connected and an atmospheric pressure portion with an open air hole which is on the opposite side to the pressure regulation diaphragm, by means of an inner vent diaphragm that is operated at a differential pressure between the negative intake pressure and atmospheric pressure, and in the inner vent diaphragm, a displacement limitation rod that protrudes from a center portion thereof is installed, a front end thereof coming in contact with a center portion of the pressure regulation diaphragm to limit displacement in a valve closing direction, and by introducing the negative intake pressure into the negative pressure introduction portion via the inner vent tube, the pressure regulation diaphragm is pressurized by the displacement limitation rod while the inner vent diaphragm is displaced to the pressure regulation diaphragm side, thereby reducing a decrease in stroke in the valve opening direction of the pressure regulation diaphragm.

In this manner, in the inner vent type regulator for the gas engine, there is a simple structure only having the displacement limitation rod protruding from the inner vent diaphragm to the pressure regulation diaphragm means that the back pressure chamber is further divided by the inner vent diaphragm, a space on the pressure regulation diaphragm side is connected to the intake passage and is used as a negative pressure introduction portion, while another space is used as an atmospheric pressure portion opened to the outside. Due to the simple structure, in addition to introducing negative intake pressure into the back pressure chamber side to avoid the over-concentration of the air-fuel ratio when the air cleaner is blocked, by pressing the pressure regulation diaphragm with the displacement limitation rod protruding from the inner vent diaphragm at the time of high load operation to limit the displacement in the valve closing direction, it is to easy to secure the necessary gaseous fuel flow rate.

Furthermore, in this case, if the negative pressure introduction portion is provided approximately in parallel relative to the pressure regulation diaphragm and is further divided into two portions by a partition with communication holes, and if a pressure regulation spring is sandwiched between the partition and the inner vent diaphragm, and the spring pressure is capable of being regulated by means of an idle flow rate regulation screw, it is possible to easily regulate the limitation level relative to the displacement of the pressure regulation diaphragm in the valve closing direction.

In addition, if a gaseous fuel supplying device includes the above-mentioned regulator for the gas engine and a mixer in which the regulator for the gas engine is connected to a venturi portion by the fuel supply tube and is connected to the upstream side of the venturi portion by the inner vent tube, and if a variable pressure vent is provided in the intake passage side of a portion of the mixer to which the inner vent tube is connected, by disposing the gaseous fuel supplying device in a fuel supply system of the gas engine, the above-mentioned effect is exhibited.

According to the present invention of the simple structure in which the back pressure chamber of the inner vent type regulator is divided by the inner vent diaphragm and the displacement limitation rod protrudes from the center portion thereof to the center portion of the pressure regulation diaphragm, it is possible to suppress the variation in air-fuel ratio to a minimum both when the air cleaner is blocked and at the time of high load operation, without being accompanied by a rise in costs.

### BRIEF DESCRIPTION OF THE DRAWINGS

FIG. 1 is a longitudinal sectional view that illustrates an arrangement of a gaseous fuel supplying device including a regulator for a gas engine and a mixer which is an embodiment in the present invention.

FIG. 2 is an enlarged partial longitudinal sectional view of the regulator of the gas engine in FIG. 1.

FIG. 3A is a partial longitudinal sectional view of an outer vent type regulator of a gas engine in the related art.

FIG. 3B is a partial longitudinal sectional view of an inner vent type regulator of a gas engine in the related art.

FIG. 4A is a graph that shows a relationship between an intake air amount and a stroke of a diaphragm according to an example in the related art.

FIG. 4B is a graph that illustrates a relationship between an intake air amount and a fuel flow rate according to an example in the related art.

### DESCRIPTION OF THE PREFERRED EMBODIMENTS

Hereinafter, embodiments for carrying out the present invention will be described with reference to the drawings.

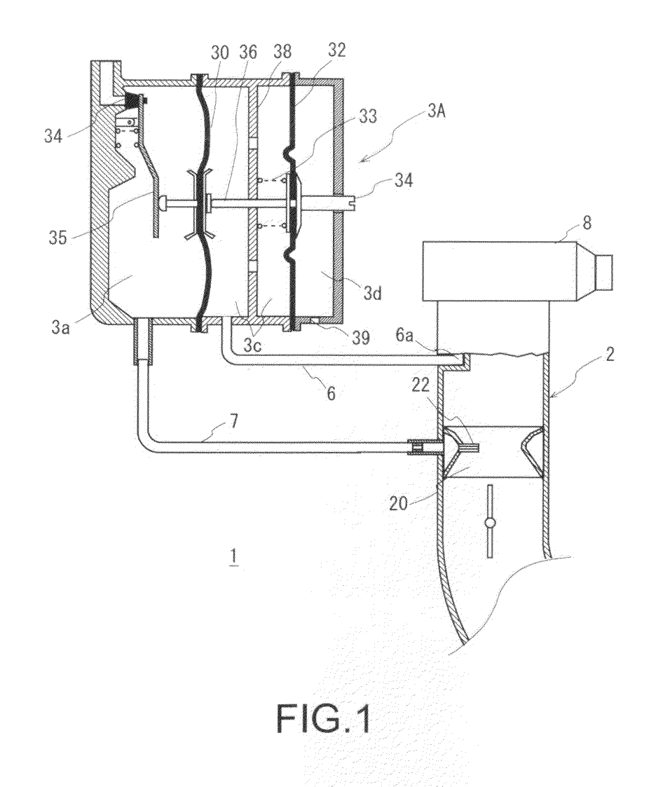

FIG. 1 is a longitudinal sectional view that illustrates an arrangement of a gas fuel supplying device 1 including a regulator 3A and a mixer 2 which is an embodiment of the present invention. The gas fuel supplying device 1 decompresses and vaporizes liquefied gas fuel such as LPG while regulating the gaseous fuel at a predetermined pressure and provides the gaseous fuel for a gas engine.

In an intake passage of a gas engine with an air cleaner 8 at a proximal end, a mixer 2 is installed which jets the gaseous fuel regulated at a predetermined pressure from a fuel nozzle 22 protruding from a venturi portion 20 and mixes the gaseous fuel with the intake air, and a regulator 3A is disposed which is connected to the mixer 2 by the fuel supply tube 7 and the inner vent tube 6, introduces the gas fuel from a fuel tank (not shown), converts the gas fuel to a gaseous fuel at a predetermined pressure, and transports the gaseous fuel to the gas engine.

The regulator 3A is divided into a pressure regulation chamber 3a and a back pressure chamber (which includes a negative pressure introduction portion 3c and an atmospheric pressure portion 3d described later) by means of a pressure regulation diaphragm 30, the pressure regulation chamber 3a has a fuel introduction valve 34 at a front end side of a valve lever 35 which is in contact with a valve rod 36 protruding from the pressure regulation diaphragm 30, and the pressure regulation chamber 3a is also connected to a fuel nozzle 22 protruding from the venturi portion 20 of the mixer 2 by means of the fuel supply tube 7.

In addition, the back pressure chamber is connected to the mixer 2 on the upstream side of the venturi portion 20 by the inner vent tube 6, and at a side facing the intake passage of the portion connected to the mixer 2, a variable pressure vent 6a opened to the upstream side is formed so as to introduce the negative intake pressure of the downstream side of the air cleaner 8 in the intake passage.

Furthermore, the back pressure chamber is divided into a negative pressure introduction portion 3c on the pressure regulation diaphragm 30 side to which the above-mentioned inner vent tube 6 is connected and an atmospheric pressure portion 3d, which is on the opposite side to the pressure regulation diaphragm 30 and has an open air hole 39, by means of an inner vent diaphragm 32 which is operated by differential pressure between the negative intake pressure and the atmospheric pressure, and in the inner vent diaphragm 32, a displacement limitation rod 36 is provided which protrudes from the center portion thereof, a front end side thereof coming in contact with the center portion of the pressure regulation diaphragm 30 to limit displacement in the valve closing direction.

That is, the regulator 3A for the gas engine is configured such that by introducing the negative intake pressure of the downstream side of the air cleaner 8 into the negative pressure introduction portion 3c via the inner vent tube 6, by means of the differential pressure between the atmospheric pressure portion 3d communicated with the outside and the negative pressure introduction portion 3c, while the inner vent diaphragm 32 is displaced to the pressure regulation diaphragm 30 side, the displacement limitation rod 36 pressurizes the center portion of the pressure regulation diaphragm 30, thereby suppressing the decrease in stroke in the pressure regulation diaphragm 30 by limiting displacement in the valve closing direction.

For that reason, when the air cleaner 8 is blocked, while the negative intake pressure is introduced into the negative pressure introduction portion 3c to suppress an excessive displacement of the pressure regulation diaphragm 30 in the valve opening direction, the over concentration of the air-fuel ratio can be suppressed, and in addition to this, at the time of high load operation or the like, by the pressure regulation diaphragm 30 being pressed by the displacement limitation rod 36, the decrease in stroke is suppressed, and an appropriate flow rate of the gaseous fuel is secured, which makes it possible to avoid problems such as engine stalling due to an overly lean air-fuel ratio.

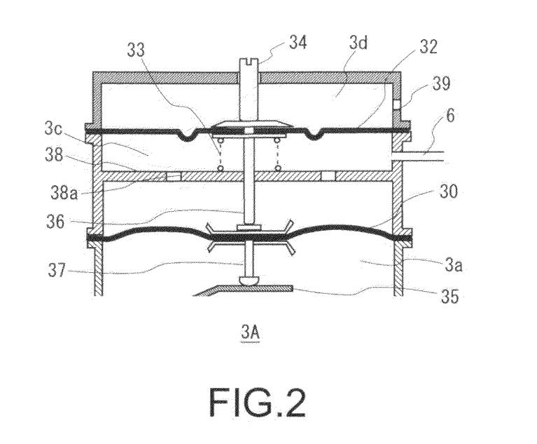

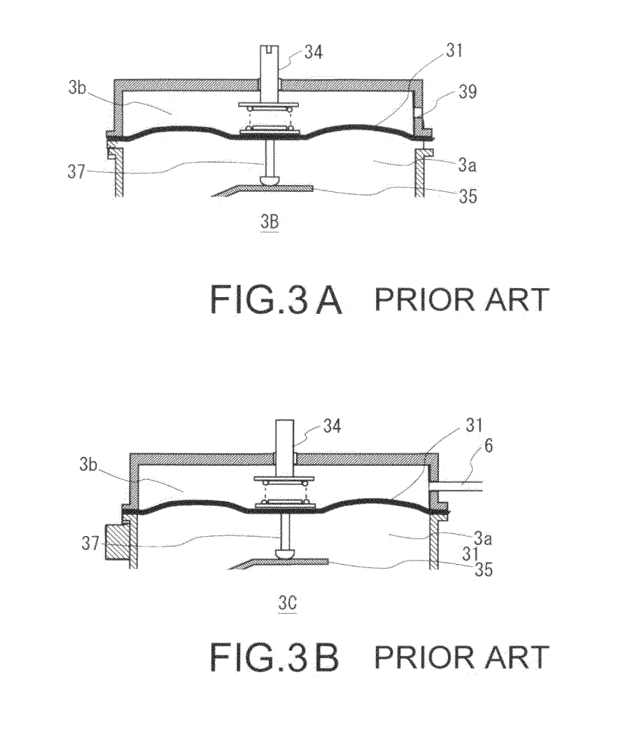

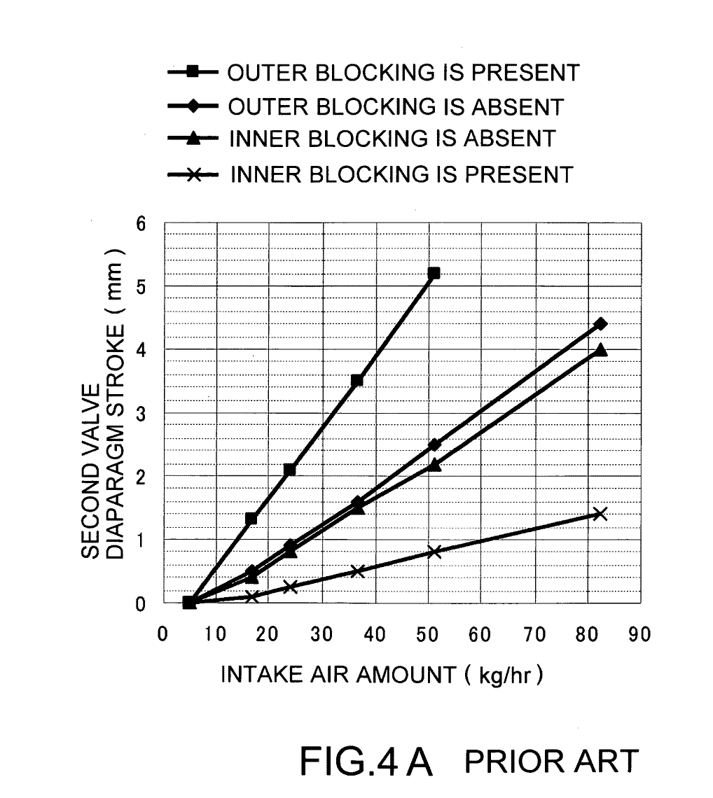

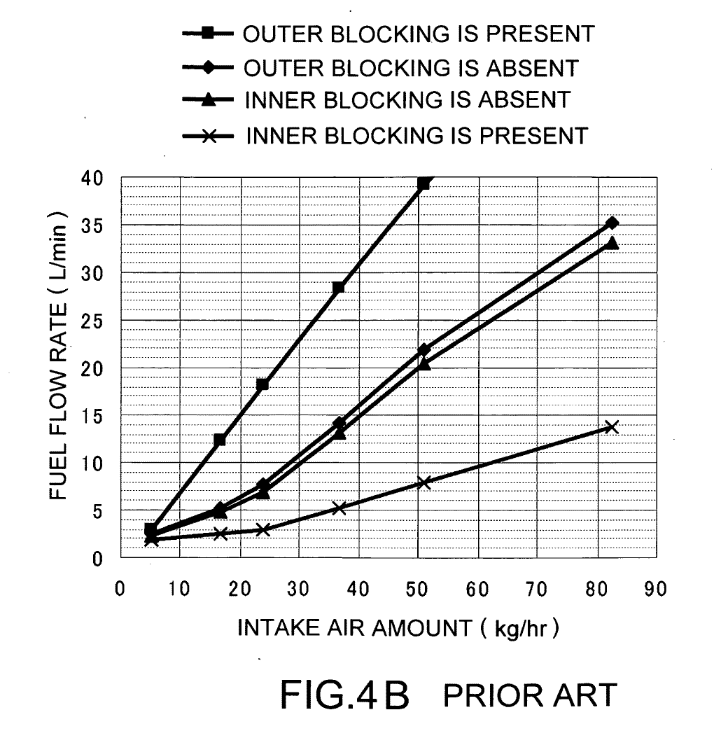

As shown in an enlarged partial longitudinal sectional view in FIG. 2, the negative pressure introduction portion 3c of the regulator 3A in the present embodiment is divided into two portions by a partition 38 parallel to the pressure regulation diaphragm 30, the partition 38 has communication holes 38a and 38a and a pressure regulation spring (a diaphragm spring) 33 is sandwiched between the inner vent diaphragm 32 and the partition 38.

In addition, at the side opposite to the displacement limitation rod 36 of the inner vent diaphragm 32, an idle flow rate regulating screw is provided which penetrates through the atmospheric pressure portion 3d with a front end thereof disposed so as to be exposed to the outside, and the spring force of the pressure regulation spring 33 is capable of being regulated, which makes it possible to regulate and set the limitation level relative to the above-mentioned displacement of the pressure regulation diaphragm 30 in the valve closing direction.

Furthermore, a variable pressure vent 6a is formed in the intake passage side of the portion in the mixer 2 to which the inner vent tube 6 is connected, and the introduction level of the negative intake pressure to the negative pressure introduction portion 3c is also capable of being regulated by means of the variable pressure vent 6a, which makes it possible to regulate and set the limitation level relative to the displacement of the pressure regulation diaphragm 30 in the valve closing direction as mentioned above.

As described above, in regard to the regulator that supplies the gaseous fuel for the gas engine, according to the present invention, variation in the air-fuel ratio is suppressed to a minimum both when the air cleaner is blocked and at the time of high load operation, without being accompanied by a rise in costs.

What is claimed is:

1. An inner vent type regulator for a gas engine in which a pressure regulation chamber and a back pressure chamber are divided by a pressure regulation diaphragm, the pressure regulation chamber has a fuel introduction valve that is opened and closed by the reciprocating displacement of the pressure regulation diaphragm, and is connected to an intake passage by a fuel supply tube, and the back pressure chamber is connected to the intake passage on the downstream side of an air cleaner by an inner vent tube, the inner vent type regulator transporting a gaseous fuel which has been regulated at a predetermined pressure, while an negative intake pressure is introduced into the back pressure chamber,
wherein the back pressure chamber is further divided into a negative pressure introduction portion on the pressure regulation diaphragm side to which the inner vent tube is connected and an atmospheric pressure portion with an open air hole that is on the opposite side to the pressure regulation diaphragm, by means of a inner vent diaphragm that is operated at a differential pressure between the negative intake pressure and an atmospheric pressure, in the inner vent diaphragm, a displacement limitation rod that protrudes from a center portion thereof is installed, a front end thereof coming in contact with a center portion of the pressure regulation diaphragm to limit displacement in a valve closing direction, and by introducing the negative intake pressure into the negative pressure introduction portion via the inner vent tube, the pressure regulation diaphragm is pressurized by the displacement limitation rod while the inner vent diaphragm is displaced to the pressure regulation diaphragm side, thereby reducing a decrease in stroke of the pressure regulation diaphragm in the valve opening direction.

2. The regulator for a gas engine according to claim 1,
wherein the negative introduction portion is provided approximately in parallel relative to the pressure regulation diaphragm and is further divided into two portions by a partition with communication holes, a pressure regulation spring is sandwiched between the partition and the inner vent diaphragm, and a spring pressure is capable of being regulated by means of an idle flow rate regulation screw.

3. A gaseous fuel supplying device comprising:
the regulator for the gas engine according to claim 1 and a mixer in which the regulator for the gas engine is connected to a venturi portion by the fuel supply tube and is connected to an upstream side of the venturi portion by means of the inner vent tube, a variable pressure vent being provided in the intake passage side of a portion of the mixer to which the inner vent tube is connected.

4. A gaseous fuel supplying device comprising:
the regulator for the gas engine according to claim 2 and a mixer in which the regulator for the gas engine is connected to a venturi portion by the fuel supply tube and is connected to an upstream side of the venturi portion by means of the inner vent tube, a variable pressure vent being provided in the intake passage side of a portion of the mixer to which the inner vent tube is connected.
